(19) United States
(12) Patent Application Publication
(10) Pub. No.: US 2003/0098627 A1
(43) Pub. Date: May 29, 2003

(54) Solid rotor shaft construction for alternating current induction motor

(76) Inventor: William A. Mitchell, Springfield, VT (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 09/994,104

(22) Filed: Nov. 26, 2001

(51) Int. Cl. H02K 21/12

(52) U.S. Cl. 310/156.08

(57) ABSTRACT

Squirrel cage type asynchronous motors such as alternating current induction motors and high speed asynchronous induction motors having a unitary rotor and shaft assembly and a method of making such a one piece, solid rotor and shaft to achieve a more stable and higher strength rotor and shaft with an increased critical frequency. The solid rotor and shaft includes a central rotor portion having a substantially larger diameter than the opposing shaft portions extending from either end of the rotor portion. Conductor bar passages are formed adjacent the outer circumferential surface of the rotor portion to accept the respective number of conductor bars making up the secondary winding in the solid rotor and shaft.

### FIELD OF THE INVENTION

The present invention relates generally to the field of squirrel cage type asynchronous motors such as alternating current induction motors and particularly to high speed asynchronous induction motors. The present invention is particularly directed to a unitary rotor and shaft assembly and method of making such a one piece, solid rotor and shaft which achieves a more stable and higher strength rotor and shaft with an increased critical frequency.

### BACKGROUND OF THE INVENTION

A typical induction motor, as well known in the art, is in essence an electric transformer having a developed magnetic circuit which is separated by an air gap into two relatively movable portions, a substantially stationary stator carrying a primary winding, and a rotatable rotor and shaft, the rotor carrying the secondary winding. When an alternating current is supplied to the primary winding on the stator an opposing current is induced in the secondary winding of the rotor which, when short circuited or closed through an external impedance, induces an opposing electrical current in the secondary winding and relative motion is produced between the primary and secondary windings due to the torque generated by the opposing electro magnetic poles. The relative motion between the primary and secondary structures produced by the electromagnetic forces corresponds to the power thus transferred across the air gap by induction.

In general, the structure of a squirrel cage type induction motor consists of the cylindrical rotor carrying a plurality of conductor bars affixed in slots on an outer periphery of the rotor. The cylindrical rotor and conductor bars are inserted within an annular core of laminated steel, the stator, carrying the primary winding in slots on its inner periphery. As an example, the primary winding is commonly arranged for a three phase power supply, with three sets of exactly similar multipolar coiled groups spaced ⅓ of a pole pitch apart. The super position of the three stationary, but alternating, magnetic fields produced by the three phase windings produces a sinusoidally distributed magnetic field revolving in synchronism with the power supply frequency. The time of travel of the field crest from one phase winding to the next being fixed by the time interval being between the reaching of the crest values by the corresponding phase currents. The direction of rotation is fixed by the time sequence of the currents in successive phase belts and so may be reversed by reversing the connections of one phase of the two or three phase motor.

As is known in the art, the alternating current in the winding of each phase therefore produces a sine wave distribution of magnetic flux around the inner periphery of the stator which is stationary in space but varying sinusoidally in time and synchronism with the supply frequencies. This magnetic field generated by the stator essentially pushes the opposing magnetic field generated in the rotor creating a torque and the relative rotation of the rotor and shaft.

The rotor of a conventional induction motor is typically constructed from a number of separate plate like laminations, usually steel or iron. A thin layer of electrical insulation can be provided between each adjacent lamination to reduce hysteresis and eddy current losses. The laminations are stacked with adjacent planar faces abutting one another and are held together by the conductor bars, usually copper. The conductor bars are inserted through the stack of rotor laminations which form the rotor, with end portions of the conductor bars extending beyond the opposite ends of the rotor. A pair of end rings is then disposed at opposite ends of the core and joined to each of the conductor bars to complete the secondary winding circuit.

After a heating and cooling process, the individual laminations making up the rotor are sandwiched tightly together due to the prestressing of each conductor bar thus clamping the laminations and end rings together. Although now a tightly bound assembly, the abutting adjacent planar faces of the individual laminations are still separate surfaces. The separated surfaces creates a boundary, the main function of which is to reduce the eddy currents and hysteresis loses in the secondary winding.

Laminations and the boundary created therebetween, are important mainly because eddy current and hysteresis losses were thought to be substantial in the rotor. Despite being held tightly together and reducing eddy current and hysteresis problems, these laminations and associated radially extending boundaries allow an amount of flexibility between the laminations.

Additionally, the laminated rotor and conductor bars are generally affixed to a motor shaft by inserting the shaft through a central passage formed by the laminated rotor and affixing the rotor and shaft together via a shrink fit, press fit, or interference fit process as is known in the art along an inner axial surface of the laminated rotor and an outer axial surface of the shaft. Thus the conventional rotor and shaft is a multi part unit being a combination of many separate parts, namely the rotor laminations, end rings, rotor bars and separate shaft, which by their very nature include a great number of abutting radial and axial surfaces.

U.S. Pat. No. 5,642,010 to Carosa et al. issued Jun. 24, 1997 describes an improved conductor bar design method of fabrication for a conductor bar design employing a T-shaped conductor bar aligned around a magnetic core forming a rotor having a minimum amount of bonding interfaces between the conductor bar and end ring portions. This patent which although uses an induction squirrel type cage motor utilizes a number of T-shaped conductor bars which are inserted in the stack of laminations of a magnetic rotor such that the head of a T on one end of a first bar and a straight portion at the other end of an adjacent bar fit closely with one another in an inter-leaving arrangement so that the opposing end rings on each end of the rotor are formed of the alternating head end and straight end portions of the adjacent T-shaped conductor bars. The rotors described here are still essentially typical laminations and end rings of a laminated magnetic rotor core for any asynchronous motor.

U.S. Pat. No. 5,801,470 to Johnson et al. issued Sep. 1, 1998 relates to a rotor and a shaft having a permanent magnetic layer and an outer retaining layer comprising a conductive low magnetic permeability material bound to a rotor shaft. Johnson et al. describes a conventional high speed permanent magnetic motor where the magnetic retention is achieved by shrinking or pressing a high strength shell over the magnets due to the magnets inability to maintain a shrink fit or interference fit during rotor rotation.

### OBJECT AND SUMMARY OF THE INVENTION

An object of the invention is to increase the longevity of high speed induction type motors by providing a new rotor and shaft design.

Another object of the invention is to raise the critical frequency of induction type motors by eliminating the joints and joined surfaces between separate rotor laminations and a separate shaft.

A still further object of the invention is to provide a solid one piece rotor and shaft supporting a secondary winding of the induction motor.

A solid, unitary rotor and shaft is formed from a single piece of metal namely iron or steel as is known in the art. The solid rotor and shaft includes a central rotor portion having a substantially larger diameter than the opposing shaft portions extending from either end of the rotor portion. A plurality of conductor bar passages are formed adjacent the outer circumferential surface of the rotor portion to accept the respective number of conductor bars making up the secondary winding in the solid rotor and shaft. The respective plurality of conductor bars are inserted in the conductor bar passages to form the solid rotor and shaft having the squirrel cage type conductor or rotor bars affixed into the rotor conductor bar passages. Such a solid rotor shaft design increases the stability and strength along the length of the rotor shaft and thus the efficiency and the life span of the solid rotor shaft and motor are substantially increased.

### BRIEF DESCRIPTION OF THE DRAWINGS

The invention will now be described, by way of example, with reference to the accompanying drawings in which:

FIG. 1 is a side elevation view of the solid rotor and shaft;

FIG. 2 is a perspective view of a rotor bar;

FIG. 3 is a partial view of the rotor and an adjacent portion of a stator;

FIG. 4 is a side cutaway view of the solid rotor and shaft and conductor bar passages; and

FIG. 5 is a partial view of the rotor and an adjacent portion of a stator detailing a rotor portion embodiment of an open slot design.

### DETAILED DESCRIPTION OF THE PREFERRED EMBODIMENTS

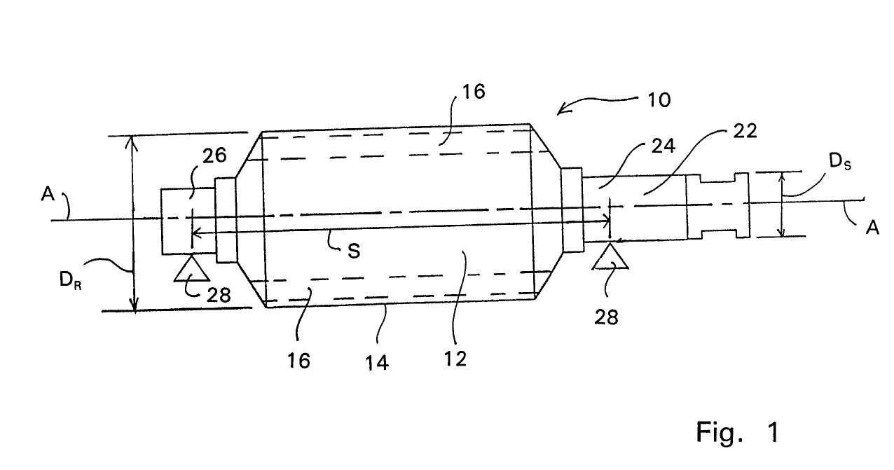

Observing FIG. 1, the solid rotor and shaft device 10 of the present invention includes a rotor portion 12 having a first and second opposing ends prescribing a cylindrical surface 14 extending therebetween about an axis A. Integrally attached to each of the first and second opposing ends of the rotor portion 12 is a respective first shaft portion 24 and a second shaft portion 26. By a solid rotor and shaft it is to be understood that the first and second shaft portions 24 and 26 and the rotor portion 12 are contiguous and integrally formed from a unitary pieces of material, for instance machined from a single piece of bar stock.

The solid rotor and shaft 10 is defined about an axis of rotation A and the rotor portion 12 and associated cylindrical surface 14 is provided with an outer diameter D_{R}, and the first and second shaft portions 24, 26 are defined by an outer diameter D_{S} also about the axis A. The rotor diameter D_{R} is larger than the shaft diameter D_{S} as can be appreciated by those of skill in the art in order to provide the necessary structure for supporting the secondary winding in the form of conductor bars 30 discussed in further detail below.

The first and second shaft portions 24 and 26 of the rotor and shaft 10 are each supported on bearing supports 28 within a motor as is also known in the art. The rotor and shaft 10 thus extends across a span S defined by the spacing of the bearing supports 28 along the axis A. The rotor portion 12 is further provided with a plurality of conductor bar passages 16 formed substantially adjacent but spaced from the outer cylindrical surface 14 and parallel to the axis A. The conductor bar passages 16 extend along the length of the cylindrical surface 14 from between the first and second opposing ends of the rotor portion 12.

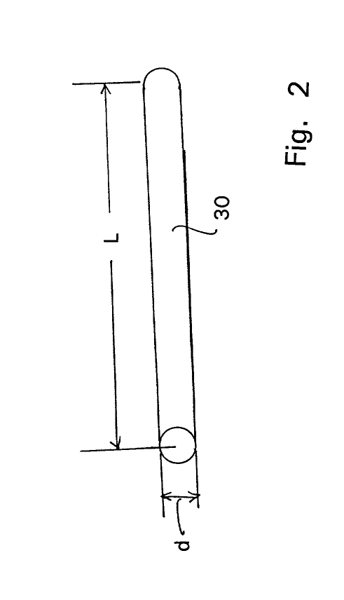

The conductor bar passages 16 are intended to receive the conductor bars 30 as shown in FIG. 2. The conductor bars 30 form the secondary winding of the rotor portion 12 which assimilates the induced electrical circuit in the rotor 12 of the motor. The conductor bars 30 are inserted in each of the plurality of conductor bar passages 16 and affixed therein by means as are known in the art for instance brazing, soldering or welding. FIG. 2 shows the conductor bar 30 having a length L and a diameter d. Although it is to be appreciated that this conductor bar could be formed having any number of cross sectional profiles other than circular as would be apparent to a person of ordinary skill in the art, for instance, it could be rectangular, oval, bell shaped or any shape as has been previously used in the industry.

It is to be appreciated that the conductor bars 30 extend substantially from the first to the second end of the rotor portion 12. The bars 30 may be connected at their ends by conductor bar rings (not shown). In one embodiment of the invention, no separate conductor bar end rings are utilized at opposing ends of the rotor. The rotor itself, which is generally steel or iron and is itself electrically conductive and performs the function of the conductor bar connective feature, i.e. the end rings. The first and second ends of the rotor portion can extend beyond the primary windings of the stator 4, and thus the first and second ends of the rotor portion 12 itself become the electrically conductive end ring material and completes the electric circuit between the respective conductor bars 30 of the secondary winding and effectuates the induced opposing magnetic field and the relative rotation of the rotor and shaft 10 without the use of separate end rings.

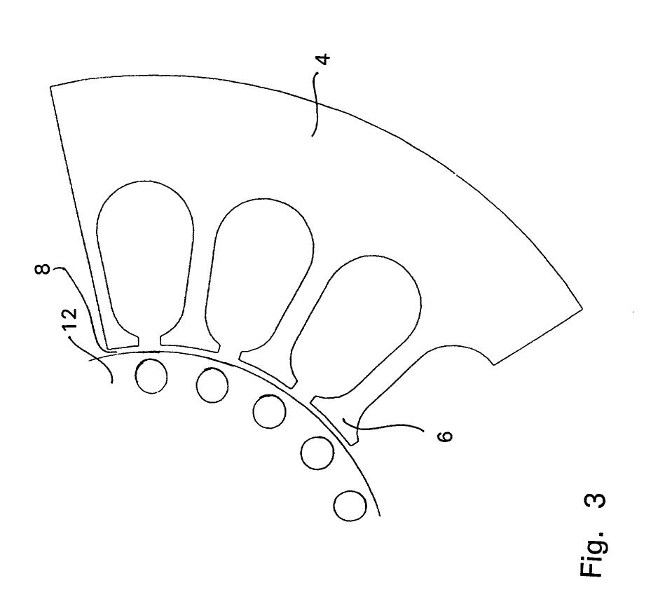

Turning now to FIG. 3, a portion of both the rotor 12 and a stator 4 are provided. The stator 4 forms an annular cavity into which the rotor and shaft 10 are inserted such that a primary winding on the stator 4 is in relative proximity with the secondary winding, i.e. the conductor bars 30 positioned in the passages 16 of the rotor portion 12. The stator 4 and the cylindrical surface 14 of the rotor portion 12 are separated by an air gap 8. Each stator 4 is provided with a series of stator teeth 6 about which the primary windings are supplied with an alternating current which, as is well known in the art, induces an opposing current across the air gap 8 in the secondary winding. The electromagnetic forces developed by the opposing currents creates the torque between the stator and rotor which causes the relative rotation between the shaft and rotor 10 and the stator 4. Again, as the concept of electromagnetic induction is well understood by those of ordinary skill in the art, no further discussion is provided.

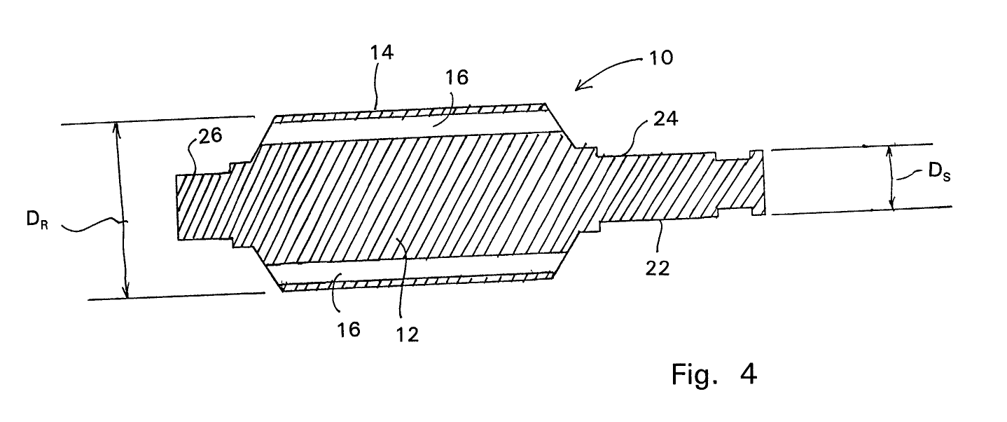

In FIG. 4 a cross-sectional view of the solid rotor and shaft 10 is provided. The solid rotor and shaft 10 of the present invention is formed in any manner as is known in the art from a single solid piece of material such as steel or iron. The rotor and shaft 10 and the respective rotor and shaft portions 12, 24 and 26 may be machined or cut on a machine to conform to the specifications as desired for a specific motor or application, specifically the diameters D_{S} of the shaft portions 24 and 26 and the diameter D_{R} of the rotor portion 12. As such machining and cutting techniques are well known in the art no further discussion is provided.

Subsequent to the cutting or machining of the diameters D_{R} and D_{S} of the shaft and rotor portions, the conductor bar passages 16 may be drilled or cut in the rotor portion 12 of the rotor shaft 10 by any means as are known in the art. Again as such operations are well known no further discussion is provided.

Thus, the rotor portion 12 and the shaft portions 24, 26 are machined or formed from a single piece of material such that there are no physically abutting radial or axial surfaces in between the shaft portions 24, 26 and the rotor portion 12. Nor are there any radial abutting surfaces between separate laminations of the rotor portion 12, nor any electrically insulating layers between the laminations. There are in fact no separate laminations, the entire rotor portion 12 and the unitary rotor shaft 10 is one piece. Thus the solid rotor and shaft 10 formed from the unitary piece of material is a solid one piece, or unitary structure.

The unitary construction has particular advantages. As is known in the art, any length of material or object spanning a distance between two supports is subject to a deflection. In the case of induction motors the larger rotor portion exerts a static deflection load across the length of the span S, this load and the associated deflection exist even during dynamic operation of the motor and limit the speed of the motor by proscribing a critical frequency for the rotor and shaft. If and when the critical frequency is approached, system degradation and failure of the bearing supports and rotor and shaft can result. The greater the deflection of the rotor and shaft the lower the critical frequency of the rotor and shaft and the greater the chance of failure or other problems. Deflection creates a substantial radial and axial stress on the rotor and shaft, and in the conventional laminated rotors these stresses allow the lamination to move due to the abutting radial and axial surfaces, ever so slightly, which, over time exploits weakness in the rotor laminations. Due to the materials typically used in end rings, for instance copper or beryllium-copper, the end rings are more susceptible to such stress and tend to fail first, leading to shearing of the rotor bars and the pulling apart of the iron rotor laminations and catastrophic motor failure.

In the known laminated and multi part rotors and shafts it is extremely difficult to attain a perfect interference fit, shrink fit or otherwise join separate surfaces. Even where excellent contact and joints are established, the joined elements add little if any strength to one another. Essentially the combination of such separate elements by these processes means that a lamination of parts or a combination of separate pieces is only as strong as the weakest element or joint. The axial and tensile strength of the shaft is critical in regards to the deflection of the rotor and shaft. The separate laminated rotor portion adds little or no strength to the shaft, no matter how good the connections and joints between separate shaft and rotor is made.

The cross-section of the solid rotor and shaft 10 shown in FIG. 4 reveals that in the present invention there are no laminations and that the rotor and shaft 10 is a single one piece construction formed about the axis A. The absence and lack of such laminations and associated radial abutting surfaces as well as the lack of axially abutting surfaces and boundaries formed between the rotor and shaft portions eliminates relative flexibility between separate elements and the one piece construction actually increases the axial and tensile strength of the rotor and shaft 10 to accommodate the bending moment and decrease deflection which is created along the length of the rotor shaft based on the span S between the bearing supports 28.

The unitary rotor and shaft 10 constructed from the single piece of material and having no axial or radial joints is substantially stronger than the previously known laminated rotors and shafts. The rotor portion 12, because it is integrally formed with the first and second shaft portions 24, adds axial and tensile strength to the rotor and shaft 10 extending between the bearing supports 28. This additional tensile strength and rigidity substantially reduces the defection of the rotor and shaft 10 across the span S.

In order to fully appreciate the present unitary construction of the rotor and shaft 10 it is important to realize that actual eddy current and hysteresis losses for which the prior art individual adjacent rotor laminations are designed, are substantially negligible in high frequency, high speed motors. Such negligible eddy current and hysteresis losses, which can be insignificant in motors of any speed, are particularly insignificant in motors attaining speeds in the range 30,000 rpm and greater.

Realizing that the frequency of magnetic flux in the rotor is essentially zero in many cases, i.e. it is only slip or slip related, essentially 1 to 3 percent of the stator core frequency and thus is relatively insignificant and thus the magnetic frequency in the rotor is also only slip related and its counter magnetic field to that developed in the stator core is only about 1 to 3 percent of the stator core frequency and eddy currents and hysteresis loss is based on this substantially insignificant percentage is extremely low and thus the boundary between the known rotor laminations which is intended to lower such losses is not necessary.

Although mainly higher speed motors, for instance, but not limited to 30,000 r.p.m. and above have been previously discussed, it is important to realize the advantageous aspects of the solid rotor and shaft in lower speed motors as well.

Related to revolutions per minute, r.p.m., as is known in the art, it is further important to understand the concept of centrifugal velocity in the present invention relative to the concept of circumferential or surface feet per minute or s.f.m., as a function of rpm with respect to the rotor, specifically, where D is the diameter of the rotor, s.f.m.=(π D/12)×rpm. The rotor is obviously the largest entity on the shaft, and, therefore, greatly affected by centrifugal forces. It is often desirable to use the largest diameter rotor possible because of the torque output of the motor is a function of the square of the diameter of the rotor and only a linear function of the length of the rotor. This of course leads to substantially increasing centrifugal stresses, which tend to have greater and greater effects on the materials used in the rotor and end rings. In fact, few motors are designed to exceed much beyond 30,000 s.f.m. due to the growth of material around this value.

As an example, because of such strength of material limitations in the rotor materials it is often crucial to ensure that the s.f.m. of a rotor is maintained at about 20,000 s.f.m. where aluminum is utilized and around 24,000 s.f.m. to 25,000 s.f.m. where copper is utilized. With the use of beryllium copper and heat treating it is possible to increase the s.f.m. to about 30,000-32,000 s.f.m. With a solid rotor, having the weaker materials substantially eliminated, such strength of material limitations are minimized, and the s.f.m. may be raised to at least the 40,000 s.f.m. range. Therefore as can be realized by those of skill in the art that where as discussed above, the concern is particularly s.f.m., as a function of r.p.m., then the present invention could also be useful in both high and low speed motors.

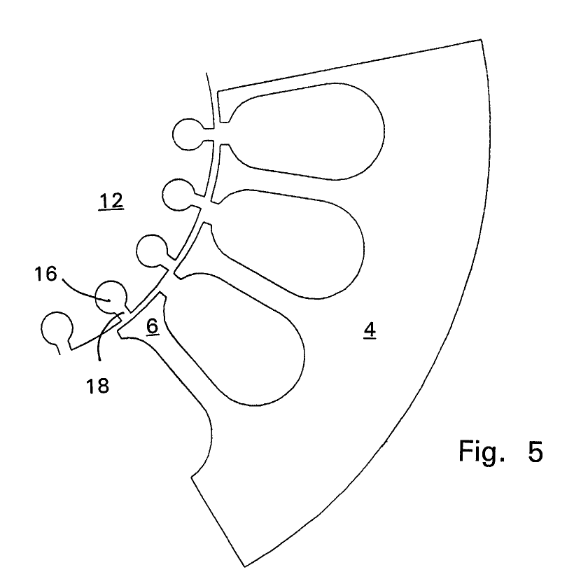

Observing FIG. 5, it is also to be appreciated that the conductor bar passages 16 may include an open slot which also extends along the length of the rotor portion 12 and communicates from the conductor bar passage 16 to intercept the cylindrical surface 14. The conductor bar passages 16, and a conductor bar 30 fit therein, are thus exposed to the air gap 8 via the slot 18 which communicates between the conductor bar passages and the outer cylindrical surface 14 of the rotor. Alternatively, a closed slot rotor design where no such slot is provided can also be used as shown in FIG. 3.

Since certain changes may be made in the above described solid, unitary rotor and shaft device, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A rotor and shaft for an asynchronous electrical motor, the rotor and shaft comprising:
a single piece of core material defining about a main axis a coaxially aligned and integrally formed rotor portion and shaft portion, the rotor portion having an outer cylindrical surface extending between a first and second ends of the rotor portion, the outer cylindrical surface of the rotor portion having a larger diameter than the shaft portion and the shaft portion includes a respective first and a second shaft ends extending from the first and second ends of the rotor portion; and
wherein a plurality of evenly separated parallel elongate passages are formed adjacent but spaced from the outer cylindrical surface of the rotor portion and parallel spaced about the main axis.

2. The rotor and shaft for an asynchronous electrical motor as set forth in claim 1 further comprising a plurality of conductor bars, each of said conductor bars being inserted within the respective elongate passage to define a squirrel cage type motor rotor and shaft.

3. The rotor and shaft for an asynchronous electrical motor as set forth in claim 2 wherein the asynchronous electrical motor is an induction motor.

4. The rotor and shaft for an asynchronous electrical motor as set forth in claim 3 wherein the single piece of core material is a magnetic material selected from the group of iron and steel.

5. The rotor and shaft for an asynchronous electrical motor as set forth in claim 4 further comprising a slot communicating between the spaced apart conductor bar passage and the cylindrical surface of the rotor portion, the slot running the length of the conductor bar passage from the first end to the second end of the rotor portion.

6. A method of forming a rotor and shaft for an asynchronous electrical motor, the method comprising the steps of:
machining from a single piece of core material a coaxially aligned and integrally formed rotor portion and shaft portion, the rotor portion defined about a main axis having an outer cylindrical surface extending between a first and second ends of the rotor portion, the outer cylindrical surface of the rotor portion having a larger diameter than the shaft portion and the shaft portion includes a respective first and a second shaft ends extending from the first and second ends of the rotor portion; and
forming a plurality of evenly separated parallel elongate passages adjacent but spaced from the outer cylindrical surface of the rotor portion and parallel spaced about the main axis.

7. The method of forming a rotor and shaft for an asynchronous electrical motor as set forth in claim 6 further comprising the step of inserting a respective conductor bar within a respective elongate passage to define a squirrel cage type motor rotor.

8. The method of forming a rotor and shaft for an asynchronous electrical motor as set forth in claim 7 further comprising the step of choosing the single piece of core material as a magnetic material selected from the group of iron and steel.

9. The method of forming a rotor and shaft for an asynchronous electrical motor as set forth in claim 7 further comprising the step of machining a slot communicating between the spaced apart conductor bar passage and the cylindrical surface of the rotor portion, the slot running the length of the conductor bar passage from the first end to the second end of the rotor portion.

10. The method of forming a single piece rotor shaft device for an asynchronous induction type electric motor as set forth in claim 9, the method further comprising the step of affixing the at least one longitudinal conductor bar in the at least one longitudinal conductor bar slot by one of brazing, soldering and welding.

11. The method of forming a single piece rotor shaft device for an asynchronous induction type electric motor as set forth in claim 10, the method further comprising the step of providing a plurality of conductor bars and not directly connecting the conductor bars with one another by end rings.

12. An electric induction motor comprising:
a first and second relatively movable portions, the first portion supporting a primary winding and the second portion supporting a secondary winding;
an air gap separating the first and second relatively movable portions;
bearing supports for rotatably supporting the second portion and second winding adjacent the first portion and primary winding;
the second portion being a unitary piece of magnetic material defining about a main axis a coaxially aligned and integrally formed rotor portion and shaft portion, the shaft portion being supported by the bearing supports and the rotor portion having an outer cylindrical surface extending between a first and second ends of the rotor portion, the outer cylindrical surface of the rotor portion having a larger diameter than the shaft portion and extending radially adjacent to but separated by the air gap from the second portion; and
wherein the second winding is formed by a plurality of separate conductor bars affixed in a respective plurality of evenly separated parallel elongate passages formed within the rotor portion adjacent but spaced from the outer cylindrical surface of the rotor portion and parallel spaced about the main axis.

13. The electric induction motor as set forth in claim 12, wherein the single piece of core material is a magnetic material selected from the group of iron and steel.

14. The electric induction motor as set forth in claim 13 further comprising a slot communicating between the spaced apart conductor bar passage and the cylindrical surface of the rotor portion, the slot running the length of the conductor bar passage from the first end to the second end of the rotor portion.

15. The electric induction motor as set forth in claim 14, wherein the motor is a high speed motor having a frequency of at least 30,000 rpm.

16. The electric induction motor as set forth in claim 13, wherein a centrifugal velocity of the rotor is evaluated in units of surface feet/minute, s.f.m., which is related to the motor speed, rpm and the diameter D of the rotor by the relationship;
s.f.m.=(πD/12)×r.p.m.; and
wherein the electric induction motor is provided with a rotor capable of operating with a centrifugal velocity of at least as great as 30,000 s.f.m. and more particularly is capable of operating at a centrifugal velocity of about 40,000 s.f.m.
